(19) United States
(12) Patent Application Publication
(10) Pub. No.: US 2014/0029057 A1
(43) Pub. Date: Jan. 30, 2014

(54) PRINTING APPARATUS, CONTROL METHOD THEREFOR, AND STORAGE MEDIUM STORING CONTROL PROGRAM THEREFOR

(71) Applicant: CANON KABUSHIKI KAISHA, Tokyo (JP)

(72) Inventor: Hirochika SATO, Kawasaki-shi (JP)

(73) Assignee: CANON KABUSHIKI KAISHA, Tokyo (JP)

(21) Appl. No.: 13/946,085

(22) Filed: Jul. 19, 2013

(30) Foreign Application Priority Data
Jul. 30, 2012 (JP) 2012-168548

(51) Int. Cl. H04N 1/00

(52) U.S. Cl. CPC H04N 1/00832; H04N 1/00278
USPC 358/1.18

(57) ABSTRACT

A printing apparatus that is capable of easily designating recording sheets to which page numbers will be given. A printing unit prints an image on a recording sheet. A setting unit sets information about whether to give a page number to a recording sheet for each block that includes one or more recording sheets among recording sheets on which images are printed by the printing unit. A control unit controls the printing unit so as to print a page number on a recording sheet based on the information set by the setting unit.

### BACKGROUND OF THE INVENTION

1. Field of the Invention

The present invention relates to a printing apparatus, a control method therefor, and a storage medium storing control program therefor.

2. Description of the Related Art

There is a printing apparatus that has an insertion function for inserting a front cover, a back cover, or an interleaf sheet when images are printed on recording sheets. The insertion function enables to determine whether original images should be printed on a front side and a back side of the front cover, the back cover, or the interleaf sheet inserted.

When this insertion function is used, a user inputs the number of page to which the interleaf sheet will be inserted through an operation unit.

For example, Japanese Laid-Open Patent Publication (Kokai) No. 2006-19904 (JP 2006-19904A) discloses a technique that generates a preview image of an original read and displays it on an operation unit, and that allows to set details of an insertion place on the preview screen so that a user easily set the insertion place when using the insertion function.

Moreover, there is an image forming apparatus that has a page numbering function to compose a page number and an original image and to output a composite image to a recording sheet.

However, the above-mentioned page numbering function did not allow a user to give a page number only to a designated sheet among recording sheets.

Moreover, the user could not easily designate pages to which page numbers would be given when the user would like to give page numbers to pages other than the covers and interleaf sheets inserted by the insertion function.

### SUMMARY OF THE INVENTION

The present invention provides a printing apparatus, a control method therefor, and a storage medium storing a control program therefor, which are capable of easily designating recording sheets to which page numbers will be given.

Accordingly, a first aspect of the present invention provides a printing apparatus comprising a printing unit configured to print an image on a recording sheet, a setting unit configured to set information about whether to give a page number to a recording sheet for each block that includes one or more recording sheets among recording sheets on which images are printed by the printing unit, and a control unit configured to control the printing unit so as to print a page number on a recording sheet based on the information set by the setting unit.

Accordingly, a second aspect of the present invention provides a control method for a printing apparatus having a printing unit that can print an image on a recording sheet comprising a setting step of setting information about whether to give a page number to a recording sheet for each block that includes one or more recording sheets among recording sheets on which images are printed by the printing unit, and a control step of controlling the printing unit so as to print a page number on a recording sheet based on the information set in the setting step.

Accordingly, a third aspect of the present invention provides a printing apparatus comprising a printing unit configured to print an image on a recording sheet, a setting unit configured to set information about whether to give a page number for each of blocks that are divided by an interleaf sheet when the printing unit prints images on recording sheets, and a control unit configured to control the printing unit so as to give a page number to a page belonging to the block that the setting unit sets to give a page number.

According to the present invention, a user can easily designate the recording sheets to which page numbers will be given.

Further features of the present invention will become apparent from the following description of exemplary embodiments with reference to the attached drawings.

### BRIEF DESCRIPTION OF THE DRAWINGS

FIG. 1 is a view showing an external appearance of a printing apparatus according to an embodiment of the present invention.

FIG. 2 is a block diagram schematically showing a hardware configuration of the printing apparatus shown in FIG. 1.

FIG. 3 is a block diagram schematically showing a configuration of a controller shown in FIG. 2.

FIG. 4 is a view schematically showing a configuration of a scanner shown in FIG. 1.

FIG. 5 is a view schematically showing a configuration of a printer shown in FIG. 1.

FIG. 6 is a view showing an operation unit shown in FIG. 1.

FIG. 7 is a view showing an initial screen displayed on a liquid crystal display in FIG. 6.

FIG. 8 is a view showing an additional function screen displayed on the liquid crystal display in FIG. 6.

FIG. 9 is a view showing a print setting screen displayed on the liquid crystal display in FIG. 6.

FIG. 10 is a view showing a cover setting screen displayed on the liquid crystal display in FIG. 6.

FIG. 11 is a view showing an interleaf sheet setting screen displayed on the liquid crystal display in FIG. 6.

FIG. 12 is a view showing an interleaf sheet detailed setting screen displayed on the liquid crystal display in FIG. 6.

FIG. 13 is a view showing the interleaf sheet detailed setting screen displayed on the liquid crystal display in FIG. 6.

FIG. 14 is a view showing the interleaf sheet setting screen displayed on the liquid crystal display in FIG. 6.

FIG. 15 is a view showing a page numbering block setting screen displayed on the liquid crystal display in FIG. 6.

FIG. 16 is a view showing a page numbering detailed setting screen displayed on the liquid crystal display in FIG. 6.

FIG. 17 is a view showing an insertion sheet count setting screen displayed on the liquid crystal display in FIG. 6.

FIG. 18 is a view for describing composition of a page number.

FIG. 19 is a flowchart showing a bundle list generation process executed by a CPU in FIG. 3.

FIG. 20 is a flowchart showing a printing process executed by the CPU in FIG. 3.

FIG. 21 is a flowchart showing a variation of the printing process executed by the CPU in FIG. 3.

FIG. 22 is a view showing the page numbering block setting screen with a sheet count displayed on the liquid crystal display in FIG. 6.

### DESCRIPTION OF THE EMBODIMENTS

Hereafter, embodiments according to the present invention will be described in detail with reference to the drawings.

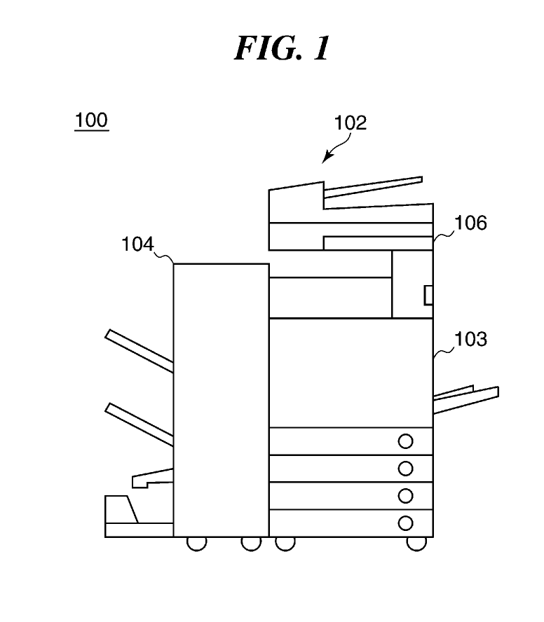

FIG. 1 is a view showing an external appearance of a printing apparatus 100 according to an embodiment of the present invention. As shown in FIG. 1, the printing apparatus 100 is provided with a scanner 102, an operation unit 106, a printer 103, and a finisher 104.

The scanner 102 corresponds to a reading unit that generates image data showing an image on an original by illuminating the original and scanning with a CCD line sensor. Color and size of the original are determined based on the image data.

The printer 103 corresponds to a printing unit that prints an image on a recording sheet, and is provided with a laser beam printer engine in the embodiment, and, thereby, prints image data on a recording sheet. The finisher 104 applies various processes, such as stapling and bookbinding, to the printed recording sheets.

The printing apparatus 100 shown in FIG. 1 is configured so that the scanner 102, the operation unit 106, the printer 103, and the finisher 104 are unified. However, the components are not necessarily unified as long as a cooperated operation is possible.

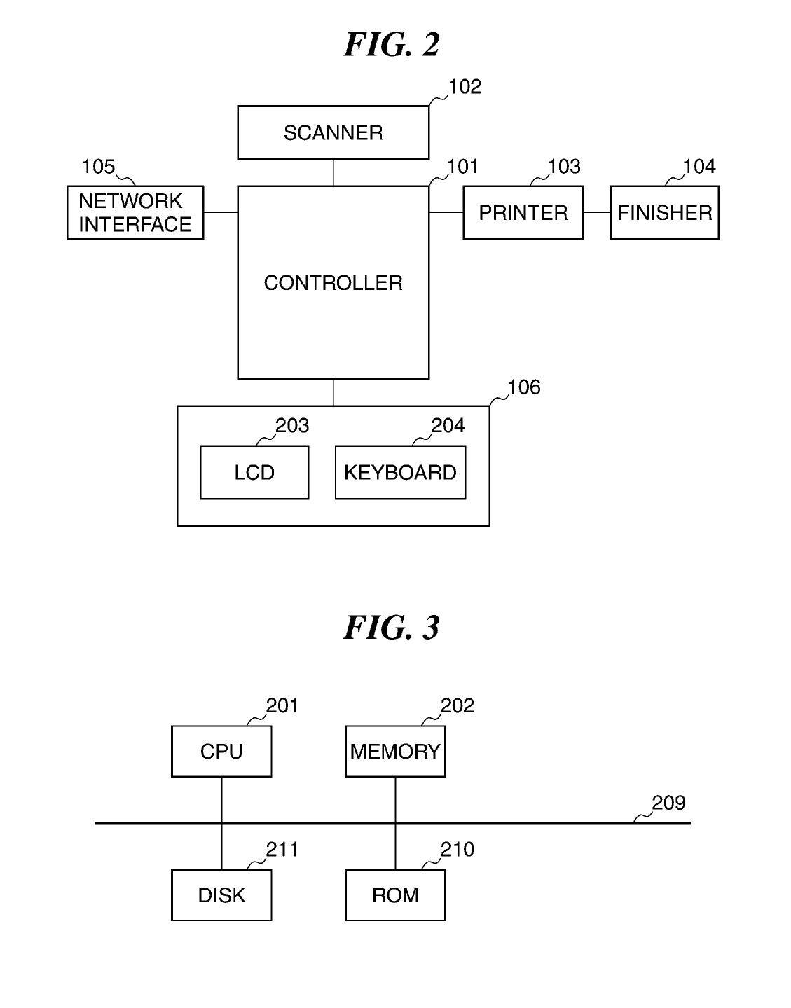

FIG. 2 is a block diagram schematically showing a hardware configuration of the printing apparatus 100 according to the embodiment of the present invention.

A controller 101 controls the entire printing apparatus 100. The scanner 102 is connected with the controller 101 via a bus, and is controlled by the controller 101. The printer 103 is connected with the controller 101 via the bus, and is controlled by the controller 101. The finisher 104 is connected with the controller 101 via the bus, and is controlled by the controller 101.

The operation unit 106 is provided with a liquid crystal display (LCD) 203 and a keyboard 204. The LCD 203 displays information under the control of the controller 101, to a user. Information about a user's operation on the keyboard is transmitted to the controller 101. Moreover, the LCD 203 is provided with a touch panel that is operational by the user, and information about a user's operation on the touch panel is transmitted to the controller 101.

A network interface 105 allows network communication with other apparatuses. The network interface 105 is connected with the controller 101 via the bus, and is controlled by the controller 101. The network interface 105 is connected to a general network like a LAN. The printing apparatus 100 may be provided with other interfaces, such as USB and Bluetooth, besides the network interface 105.

FIG. 3 is a block diagram schematically showing a configuration of the controller 101 shown in FIG. 2.

As shown in FIG. 3, the controller 101 consists of a CPU 201, a memory 202, a ROM 210, and a disk 211, which are mutually connected via a bus 209.

The CPU 201 controls the controller 101. The memory 202 is a volatile memory like an SRAM, and is used as a storage area for image data and programs, and a work area for the CPU 201.

The ROM 210 is a nonvolatile memory like a flash memory, and stores a boot program and various programs that are executed by the CPU 201 to perform processes that are shown in flowcharts mentioned later.

The disk 211 is a hard disk, an SSD, or the like, and stores image data and programs.

The CPU 201 can apply various processes, such as image composition, to the image data stored in the memory 202 and the disk 211. In the embodiment, especially, the CPU 201 can compose a numeral showing a page number with an image.

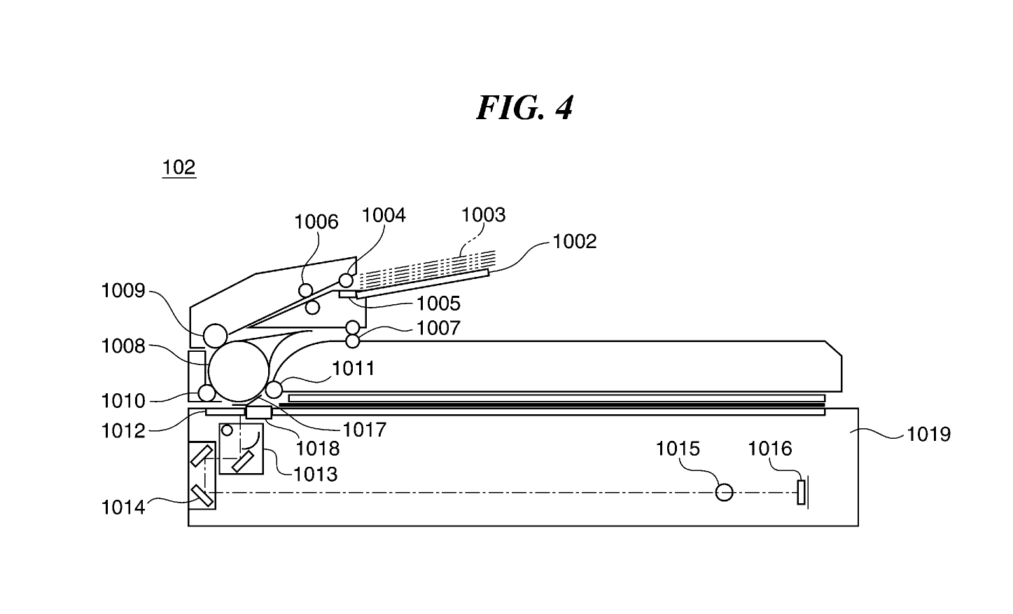

FIG. 4 is a view schematically showing a configuration of the scanner 102 shown in FIG. 1. As shown in FIG. 4, the scanner 102 reads an image formed on an original 1003 by conveying the original 1003 with respect to an exposure unit 1013 of the original reading unit 1019.

The original 1003 is set on an original tray 1002. An original feeding roller 1004 makes a pair with a separation pad 1005, and thereby the original 1003 is conveyed one by one.

The conveyed original 1003 is further conveyed by an intermediate roller pair 1006, and is conveyed by a large roller 1008 and a first driven roller 1009. Next, the original 1003 is conveyed by the large roller 1008 and a second driven roller 1010.

The original 1003 conveyed by the large roller 1008 and the second driven roller 1010 passes through a gap between a stream reading glass 1012 and an original guide plate 1017, and is conveyed by the large roller 1008 and a third driven roller 1011 via a jump base 1018.

The original 1003 conveyed by the large roller 1008 and the third driven roller 1011 is ejected by an original ejection roller pair 1007.

It should be noted that the original 1003 is conveyed through the gap between the stream reading glass 1012 and the original guide plate 1017 so that the original 1003 is forced to contact with the stream reading glass 1012 by the original guide plate 1017.

When the original 1003 passes over the stream reading glass 1012, the side that is in contact with the stream reading glass 1012 is exposed by the exposure unit 1013. The reflected light from the original 1003 is guided to a mirror unit 1014. A lens 1015 concentrates the reflected light to form an image on a CCD sensor unit 1016. The CCD sensor unit 1016 converts the formed image into an electrical signal, which is transmitted to the controller 101 as image data.

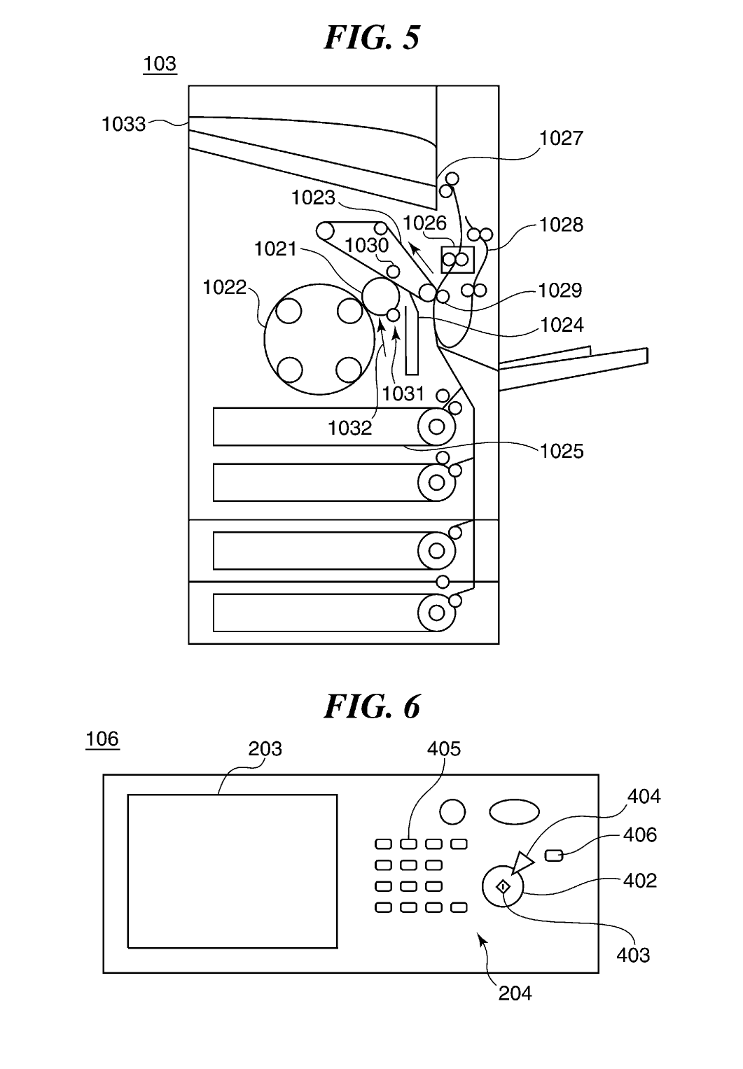

FIG. 5 is a view schematically showing a configuration of the printer 103 shown in FIG. 1. As shown in FIG. 5, the printer 103 is configured to print a full-color image with four color components such as CMYK.

A primary electrostatic charger 1031 charges a photosensitive drum 1021 at a specific polar potential. An exposure unit (not shown) emits a laser beam modulated according to a signal from the controller 101, and a portion indicated by an arrow 1032 on the photosensitive drum 1021 is exposed to the laser beam. Thus, an electrostatic latent image corresponding to a first color component is formed.

Then, the electrostatic latent image is developed by one of four development devices in a development unit 1022, and forms a toner image. An intermediate transfer belt 1023 is driven in a direction of an arrow. Next, the toner image of the first color component formed on the photosensitive drum 1021 is transferred to the intermediate transfer belt 1023 by means of an electric field formed by a primary transfer roller 1030 at the connecting position between the photosensitive drum 1021 and the intermediate transfer belt 1023.

After transferring to the intermediate transfer belt 1023, the cleaning unit 1024 cleans the surface of the photosensitive drum 1021. When this process is repeated successively for the other three color components, a full-color toner image is formed on the intermediate transfer belt 1023. It should be noted that a single color toner image requires a single transferring process only.

The toner image transferred to the intermediate transfer belt 1023 is printed on a recording sheet fed from a cassette 1025 by a secondary transfer roller 1029.

A fixing unit 1026 heats the recording sheet onto which the toner image has been printed to fix the toner image to the recording sheet. In the case of single side printing, the recording sheet is ejected to an ejection tray 1033 as-is after fixing. In the case of double-side printing, the recording sheet is circulated after fixing using an inversion path 1028.

FIG. 6 is a view showing the operation unit 106 shown in FIG. 1. As shown in FIG. 6, the operation unit 106 is provided with the LCD 203 and the keyboard 204 as indicated in FIG. 2.

The LCD 203 displays operation screens and softkeys. A start key 402 is used when starting an operation for reading an original image. A two-color LED 403 is arranged at the center of the start key 402. The emission of green light of the LED 403 shows that the start key 402 is available, and the emission of red light shows that the start key 402 is unavailable.

A stop key 404 is used for stopping an operation in action. A ten-key pad 405 consists of buttons of numerals and characters, and is used when the number of copies is set or the screen on the LCD 203 is changed. A user mode key 406 is used when performing various settings.

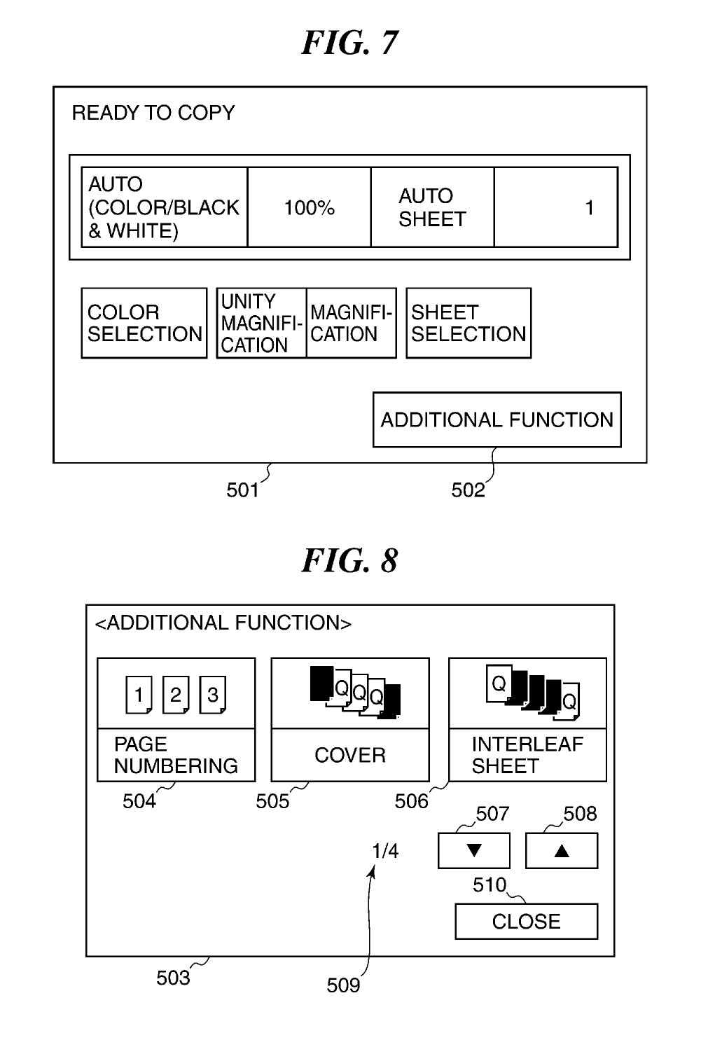

FIG. 7 is a view showing an initial screen 501 displayed on the LCD 203 in FIG. 6.

In the initial screen 501 in FIG. 7, a user can set magnification and a recording sheet. The CPU 201 stores the information that shows the set-up magnification and recording sheet as a job set value in the memory 202, and applies it to a copy job started by depressing the start key 402. It should be noted that a copy job prints an image of an original read by the scanner 102 on a recording sheet by the printer 103 according to set-up values of the copy job set by the user.

Moreover, depression of an additional function button 502 allows the user to set various functions.

FIG. 8 is a view showing an additional function screen 503 displayed on the LCD 203 in FIG. 6. The additional function screen 503 shown in FIG. 8 is displayed when the additional function button 502 in FIG. 7 is pushed.

In the additional function screen 503, when a user depresses buttons, such as a page numbering button 504, a front cover button 505, and an interleaf sheet button 506, detailed setting of the applicable function can be performed.

When the user depresses a scroll down button 507 or a scroll up button 508, the screen is scrolled, which enables selection of other functions. A screen number 509 shows the sequence number of the current screen among the total number of the additional function screen.

When the user depresses a close button 510, the display returns to the initial screen 501. The CPU 201 stores the information that was set in the additional function screen 503 as the job set value in the memory 202, and applies it to a copy job started by depressing the start key 402.

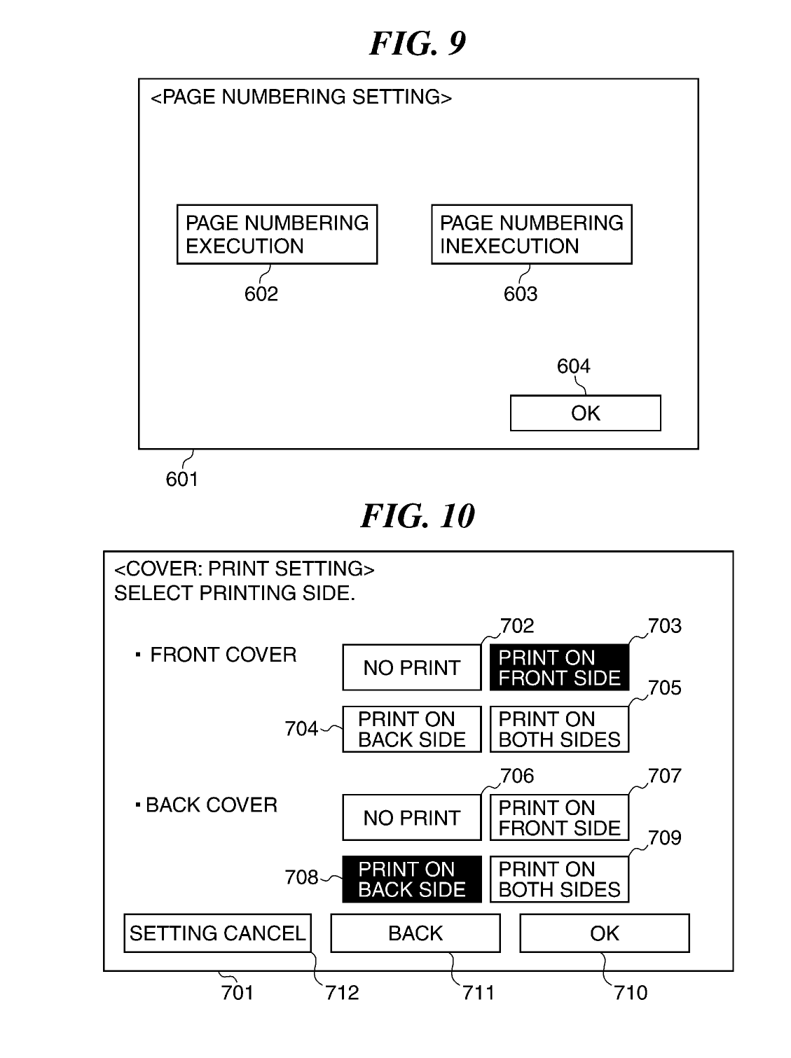

FIG. 9 is a view showing a print setting screen 601 displayed on the LCD 203 in FIG. 6. The print setting screen 601 shown in FIG. 8 is displayed when the page numbering button 504 in FIG. 8 is pushed.

The CPU 201 stores the information that validates a page numbering function as the job set value in the memory 202, when a page numbering execution button 602 is pushed.

When a page numbering inexecution button 603 is pushed on the other hand, the CPU 201 stores the information that invalidates the page numbering function as the job set value in the memory 202. The page numbering execution button 602 and the page numbering inexecution button 603 can be depressed exclusively. When the print setting screen 601 is displayed, the page numbering inexecution button 603 is selected as a default state. When a user selects one of the buttons and depresses an OK button 604, the additional function screen 503 shown in FIG. 8 is displayed.

FIG. 10 is a view showing a cover setting screen 701 displayed on the LCD 203 in FIG. 6. The cover setting screen 701 shown in FIG. 10 is displayed when the front cover button 505 in FIG. 8 is pushed.

A user can perform print settings for a front cover and a back cover in the cover setting screen 701. Buttons 702 through 705 are used to perform the print setting for the front cover. The user can perform the print setting for the front cover by depressing any one of the buttons 702 through 705.

On the other hand, buttons 706 through 709 are used to perform the print setting for the back cover. The user can perform the print setting for the back cover by depressing any one of the buttons 706 through 709. The example shown in FIG. 10 is set that the front side of the front cover is printed and the back side of the back cover is printed.

When the user selects any buttons of the buttons 702 through 709 and depresses an OK button 710, the CPU 201 stores the information set up with the selected buttons as the job set value in the memory 202. Moreover, a user's depression of a back button 711 displays the additional function screen 503 in FIG. 8.

When a setting cancel button 712 is pushed, the CPU 201 deletes the job set value about the front cover and the back cover that is stored in the memory 202, and displays the additional function screen 503.

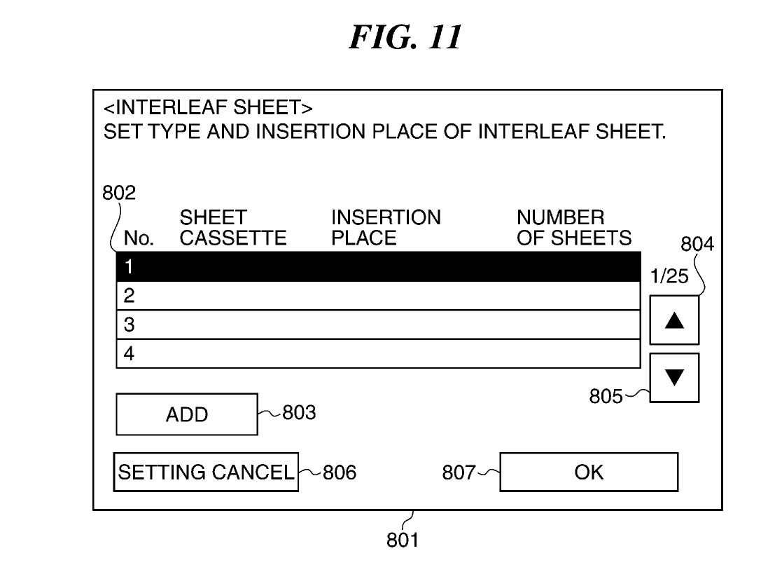

FIG. 11 is a view showing an interleaf sheet setting screen 801 displayed on the LCD 203 in FIG. 6. The interleaf sheet setting screen 801 shown in FIG. 11 is displayed when the interleaf sheet button 506 in FIG. 8 is pushed.

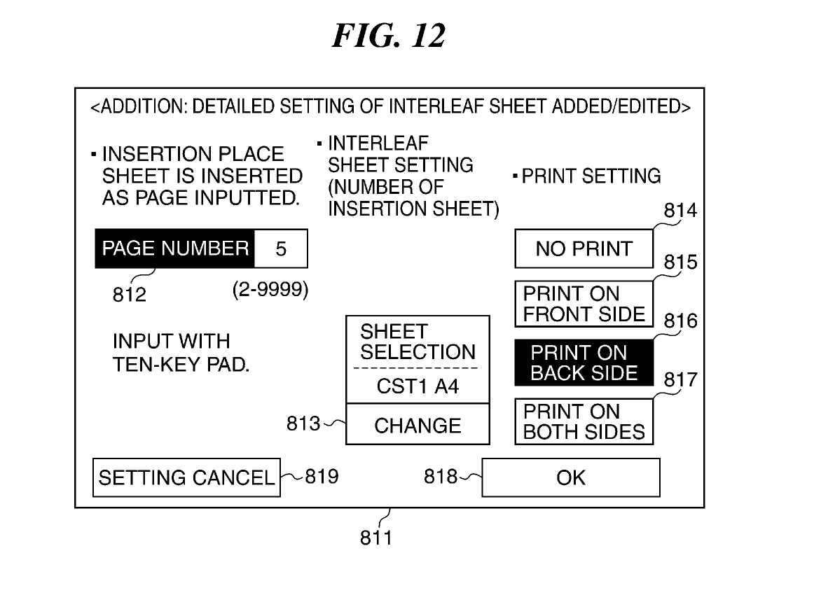

The settings for respective interleaf sheets are displayed in an interleaf sheet setting list 802. The settings displayed here are contents set up on an interleaf sheet detailed setting screen 811 shown in FIG. 12 that will be displayed by depressing the addition button 803. It should be noted that the settable number of the interleaf sheets is 100 in this embodiment.

A user can scroll the interleaf sheet setting list 802 by depressing a scroll up button 804 or a scroll down button 805.

When the user depresses an OK button 807, the CPU 201 stores the interleaf sheet setting value set up on the interleaf sheet detailed setting screen 811 into the memory 202 as the job set value, and displays the additional function screen 503.

On the other hand, when the user depresses a setting cancel button 806, the CPU 201 deletes all the interleaf sheet setting values stored as the job set value in the memory 202, and displays the additional function screen 503.

FIG. 12 is a view showing the interleaf sheet detailed setting screen 811 displayed on the LCD 203 in FIG. 6. The interleaf sheet detailed setting screen 811 in FIG. 12 is displayed when the addition button 803 in FIG. 11 is pushed as mentioned above.

When a user depresses an insertion place setting button 812, an insertion place becomes settable. The insertion place is set up with reference to an original. The user can set the number of 2 through 9999 as the insertion place using the ten-key pad 405.

The user can determine a cassette that supplies interleaf sheets to insert, when the user depresses an interleaf sheet cassette setting button 813. Moreover, the user can perform a print setting for the interleaf sheet by depressing any one of buttons 814 through 817.

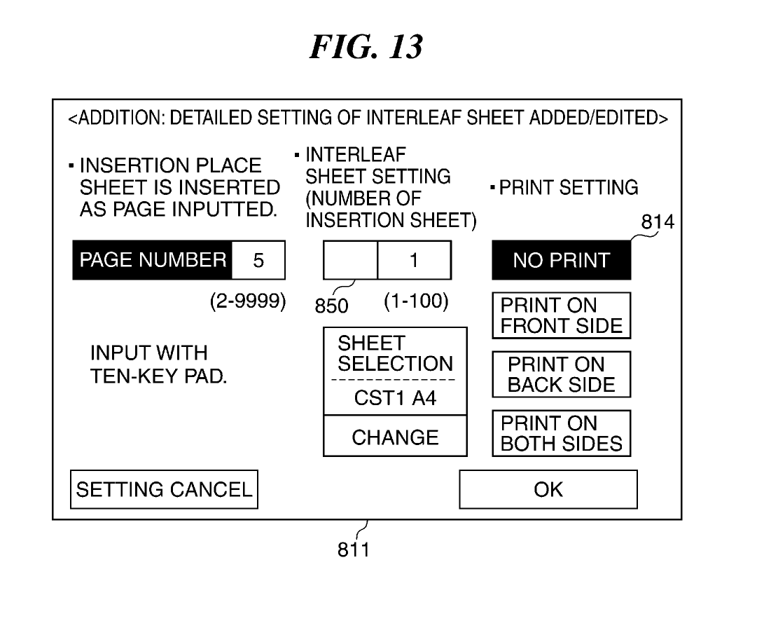

The no-print button 814 is used to insert an interleaf sheet of which neither side is printed to the insertion place set by the insertion place setting button 812. When the user depresses the no-print button 814, the interleaf sheet detailed setting screen 811 in FIG. 13 is displayed.

A front-side print button 815 is used to insert an interleaf sheet to the insertion place set by the insertion place setting button 812 and to print an original image on the front side of the interleaf sheet. For example, when the number of originals is “10” and the insertion place is “5”, an interleaf sheet is inserted next to the recording sheet on which the image of the fourth original is printed, the image of the fifth original is printed on the front side of the interleaf sheet, and the back side of the interleaf sheet becomes a blank page.

A back-side print button 816 is used to insert an interleaf sheet to the insertion place set by the insertion place setting button 812 and to print an original image on the back side of the interleaf sheet. For example, when the number of originals is “10” and the insertion place is “5”, an interleaf sheet is inserted next to the recording sheet on which the image of the fourth original is printed, the image of the fifth original is printed on the back side of the interleaf sheet, and the front side of the interleaf sheet becomes a blank page.

A both-side print button 817 is used to insert an interleaf sheet to the insertion place set by the insertion place setting button 812 and to print original images on the both sides of the interleaf sheet. For example, when the number of originals is “10” and the insertion place is “5”, an interleaf sheet is inserted next to the recording sheet on which the image of the fourth original is printed, the image of the fifth original is printed on the front side of the interleaf sheet, and the image of the sixth original is printed on the back side of the interleaf sheet.

When the user pushes any one of the buttons 814 through 817 and depresses an OK button 818, the CPU 201 adds the insertion place, the number of the interleaf sheets, the interleaf sheet cassette, and the print setting to the job set value as interleaf sheet setting information. Then, the CPU 201 stores the interleaf sheet setting information into the memory 202, and displays the interleaf sheet setting screen 801. At this time, the CPU 201 assigns an interleaf sheet number to the interleaf sheet setting information.

On the other hand, when the user depresses a setting cancel button 819, the CPU 201 displays the interleaf sheet setting screen 801 without storing the job set value of the interleaf sheet set on the interleaf sheet detailed setting screen 811 into the memory 202.

FIG. 13 is a view showing the interleaf sheet detailed setting screen 811 displayed on the LCD 203 in FIG. 6. The interleaf sheet detailed setting screen 811 shown in FIG. 13 displays an interleaf sheet number setting button 850 in addition to the elements on the interleaf sheet setting screen 801 in FIG. 12, and is displayed when the no-print button 814 in FIG. 12 is pushed.

The interleaf sheets of the number inputted with this interleaf sheet number setting button 850 will be inserted. For example, when the number of originals is “10” and the insertion place is “5”, interleaf sheets of the setting number are inserted between the recording sheet on which the image of the fourth original is printed and the recording sheet on which the image of the fifth original is printed.

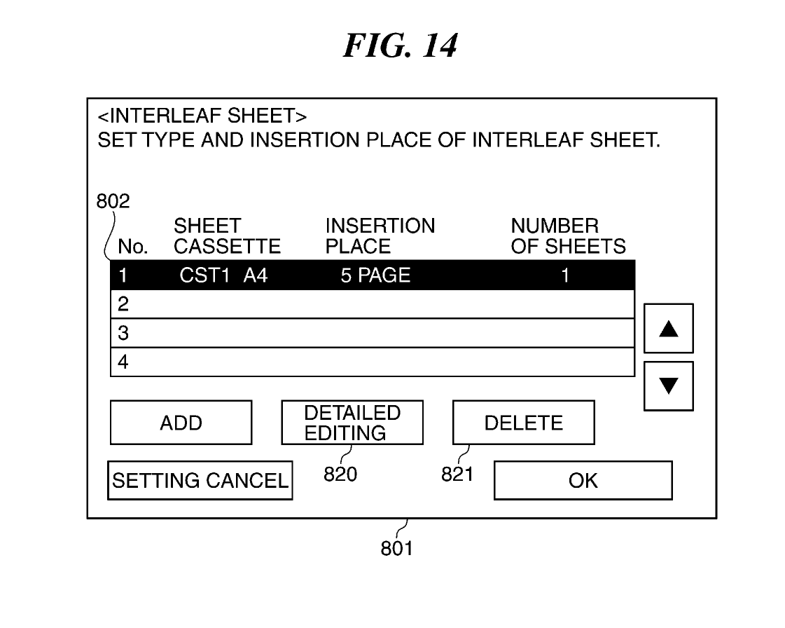

FIG. 14 is a view showing the interleaf sheet setting screen 801 displayed on the LCD 203 in FIG. 6. The interleaf sheet setting screen 801 shown in FIG. 14 is displayed when the user sets that the insertion place is “5”, the interleaf sheet cassette is “CST1”, and an image is printed on the back side of the interleaf sheet on the interleaf sheet detailed setting screen 811 in FIG. 12.

The first interleaf sheet setting (the interleaf sheet number 1) is displayed on the line of “No. 1” in the interleaf sheet setting list 802. Moreover, the above-mentioned interleaf sheet setting includes the sheet cassette that supplies a sheet, the insertion place, and the number of insertion sheets, as shown in FIG. 14.

A user's depression of the line of the interleaf sheet setting displayed on the interleaf sheet setting list 802 will display a detailed editing button 820 and a deletion button 821.

For example, when the user depresses the detailed editing button 820 under the condition where the line of No. 1 is selected in the interleaf sheet setting list 802, the interleaf sheet detailed setting screen 811 in FIG. 10 is displayed and the user is allowed to change the setting.

When the user performs a new interleaf sheet setting by depressing the addition button 803 on the interleaf sheet detailed setting screen 811 displayed, the interleaf sheet number incremented is given to the new interleaf sheet setting. The setting is displayed on the interleaf sheet setting list 802 with top alignment. For example, if the line of No. 2 is blank, the new setting will be displayed on the line of No. 2.

On the other hand, when the user depresses the deletion button 821 under the condition where the line of No. 1 is selected in the interleaf sheet setting list 802, the interleaf sheet setting indicated on the line of No.1 is deleted from the job set value. Then, if there is a following interleaf sheet setting in the interleaf sheet setting list 802, the interleaf sheet number thereof will be advanced to a high order number.

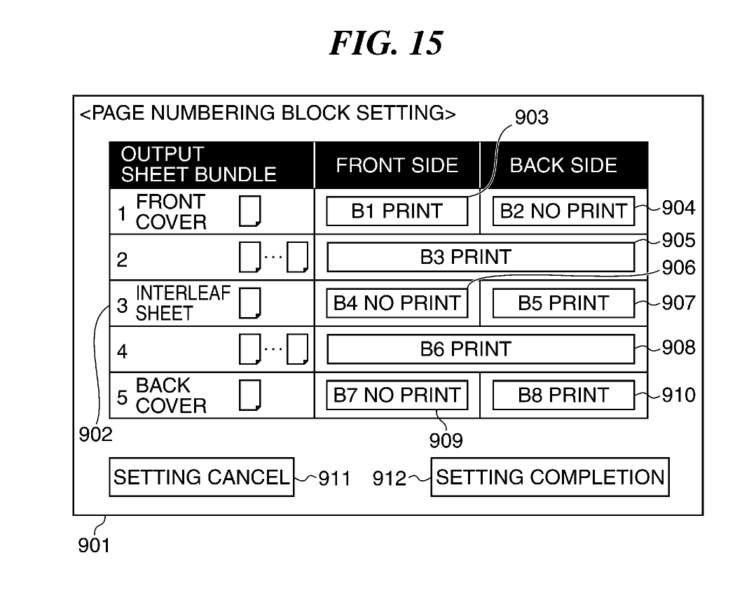

FIG. 15 is a view showing a page numbering block screen 901 displayed on the LCD 203 in FIG. 6.

The page numbering block setting screen 901 shown in FIG. 15 is displayed immediately after pressing the start key 402 for starting a copy job under the condition where the page numbering is valid in the print setting screen 601 in FIG. 9.

The CPU 201 reads the job set value stored in the memory 202, analyzes a configuration of output sheet bundles based on the set values for the front and back covers and the set value for the interleaf sheet, and displays the configuration in the page numbering block list 902. The page numbering block list 902 displays the types of the output sheet bundles, and distinctions between print and no-print of the front and back sides for every output sheet bundle. The types of the output sheet bundles are classified into a front cover, a body, an interleaf sheet, and a back cover. The body corresponds to body sheets that are recording sheets other than the front cover, the interleaf sheets, and the back cover. Moreover, sheet-shaped icons, which indicate the front cover, the interleaf sheet, the back cover, and the body sheets, are shown in the page numbering block setting screen 901.

If the front cover and the back cover are set in the cover setting screen 701, the icons for the front and back covers will be displayed in the column of the output sheet bundle. On the other hand, if the front cover and the back cover are not set in the cover setting screen 701, the icons for the front and back covers will not be displayed in the column of the output sheet bundle.

Moreover, if the interleaf sheet is set in the interleaf sheet setting screen 801, an icon for every interleaf sheet bundle set will be displayed. When the front cover bundle and the interleaf sheet bundle are continuously printed from the insertion place of the interleaf sheet bundle, the icon showing the body sheet bundle is not displayed between the icon showing the front cover bundle and the icon showing the interleaf sheet bundle. Similarly, when the interleaf sheet bundles are continuously printed from the insertion place of the interleaf sheet bundle, the icon showing the body sheet bundle is not displayed between the icons showing the interleaf sheet bundles.

When the cover bundle or the interleaf sheet bundle and the interleaf sheet bundle are not continuously printed from the insertion place of the interleaf sheet bundle, the icon showing the body sheet bundle is displayed between the icon showing the cover bundle or the interleaf sheet bundle and the icon showing the interleaf sheet bundle. The icon showing the body sheet bundle is also displayed between icon showing the last interleaf sheet bundle and the icon showing the back cover bundle.

The columns for the front side and the back side in the page numbering block list 902 show the setting ranges of the page numbering (the page numbering blocks), and page numbering detailed setting buttons 903 through 910 are displayed therein. The page numbering blocks of the body sheet bundles are located between the page numbering block of the front cover and the page numbering block of the back cover, and are divided by the page numbering block of the interleaf sheet.

Since the print settings for front and back sides are separately defined in each of the front cover bundle, the interleaf sheet bundle, and the back cover bundle, the page numbering detailed setting buttons 903, 904, 906, 907, 909, and 910 are independently arranged for the front and back sides.

On the other hand, the page numbering detailed setting buttons 905 and 908, which are common to the front and back sides, are displayed for the body sheet bundles. In an actual page numbering operation, a page number is printed on the front side only in the case of the single side printing, and page numbers are printed on both the front and back sides in the case of the double-side printing.

Moreover, each of the page numbering detailed setting buttons 903 through 910 may display characters showing whether a page number is printed or not. In this case, the characters corresponding to the setting values are displayed on the buttons for the front cover bundle, the back cover bundle, and the interleaf sheet bundle. And the characters showing that a page number is printed are displayed on the buttons for the body sheet bundles.

Thus, when the characters showing whether a page number is printed or not are displayed on the buttons, a user can recognize output before printing, which reduces frequency of wrong page numbering settings that are different from a user's intention.

The cover setting screen 701 in FIG. 10 shows the settings where an image is printed on the front side of the front cover and an image is printed on the back side of the back cover. Moreover, the interleaf sheet detailed setting screen 811 in FIG. 12 and the interleaf sheet setting screen 801 in FIG. 14 show the setting where one interleaf sheet is inserted and an image is printed on the back side of the interleaf sheet.

At this time, the output sheet bundles are classified into the front cover (bundle 1), the back cover (bundle 5), the interleaf sheets (bundle 3), and the body sheets (the bundle 2 and bundle 4) as shown in the page numbering block list 902 in FIG. 15.

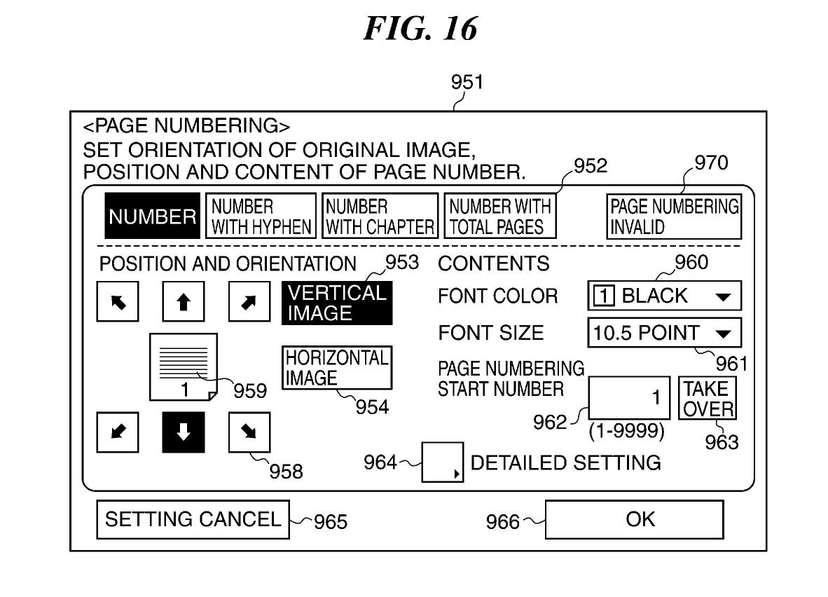

When the user depresses the setting completion button 912 in this state, the CPU 201 fixes the job set value. Specifically, a page numbering detailed setting screen in FIG. 16 is displayed by depressing one of the page numbering detailed setting buttons 903 through 910, and the job set value corresponding to the page numbering setting set on the page numbering detailed setting screen is fixed.

On the other hand, when the user depresses a setting cancel button 911, the CPU 201 cancels the page numbering setting and fixes the job setting value.

Thus, the recording sheets include the front cover, the interleaf sheet, the back cover, and the body sheets in this embodiment. Then, there are a block of the front cover, a block of the interleaf sheet, a block of the back cover, and blocks of the body sheets as block units.

As shown in FIG. 15, the page numbering block setting screen 901 including the icons showing the block of the front cover, the block of the interleaf sheet, the block of the back cover, and the blocks of the body sheets that are arranged in the outputting order from the printing apparatus 100, is displayed on the LCD 203.

Moreover, the user can select whether a page number is printed or not for each of the front cover, the interleaf sheet, and the back cover by using the page numbering block setting screen 901.

FIG. 16 is a view showing a page numbering detailed setting screen 951 displayed on the LCD 203 in FIG. 6.

The page numbering detailed setting screen 951 in FIG. 16 is displayed when one of the page numbering detailed setting buttons 903 through 910 in FIG. 15 is pushed.

A detailed setting for a page numbering block concerned is available on the page numbering detailed setting screen 951.

A button group 952 includes buttons for setting a page numbering style. The user can select any one of a “number”, a “number with hyphen”, a “number with chapter”, and a “number with total pages” as a page numbering style. FIG. 16 shows the state where the “number” is selected and the color of the button is inverted.

Moreover, a page numbering invalid button 970 is used not to give a page number to the page numbering block concerned. When the page numbering invalid button 970 is pushed, the CPU 201 sets so as not to give page numbers to the pages belonging to the block corresponding to the detailed setting button selected on the screen shown in FIG. 15.

When the page numbering invalid button 970 is pushed, all the buttons displayed on the page numbering detailed setting screen 951 for setting the page numbering cannot be selected. The page numbering invalid button 970 corresponds to a setting unit that sets the recording sheets to which page numbers are not given as a block unit containing one or more recording sheets, when images are printed using recording sheets.

When the page numbering invalid button 970 is released, the CPU 201 sets so as to give page numbers to the pages belonging to the block corresponding to the detailed setting button selected on the screen shown in FIG. 15. A user can easily designate whether page numbers are given or not by using the page numbering invalid button 970. That is, when the page numbering execution button 602 is pushed on the screen shown in FIG. 9, the CPU 201 once sets to give page numbers to all the pages sequentially.

Then, the CPU 201 sets so as not to give page numbers to the pages belonging to the designated block when receiving the designation of the block to which a page number is not given on the screen shown in FIG. 15. When the page numbering inexecution button 603 is pushed on the screen shown in FIG. 9, the CPU 201 may once set not to give page numbers to all the pages, and may set to sequentially give page numbers to the pages belonging to the block designated on the screen shown in FIG. 15.

A “vertical image” button 953 and a “horizontal image” button 954 can be exclusively selected to set an orientation of characters added by the page numbering.

Print position setting buttons 958 indicate “upper left”, “upper center”, “upper right”, “lower left”, “lower center”, and “lower right”, respectively, by orientations of arrows displayed on the buttons. A user can select one of the print position setting buttons 958. In FIG. 16, the “lower center” is selected and an output image 959 of the printing position is displayed in the center of the print position setting buttons 958.

A “font color” button 960 is used to set a color of a page number. When a user depresses the button 960, a list of colors (black and other colors) is displayed to allow the user to select any one color.

A “font size” button 961 is used to designate a size of a page number. When a user depresses the button 961, a list of sizes (10.5 point and other points) is displayed to allow the user to select any one size.

A “page numbering start number” input area 962 is used to designate the start number of the page numbering. A user sets the start number through the ten-key pad 405. Thus, the embodiment allows a user to set the start number of the page numbers given to body sheets continuously outputted from the printing apparatus 100.

A takeover button 963 is used to set that the page numbering restarts from the next to last page number of the previous page numbering block. The input to the “page numbering start number” input area 962 and the set of the takeover button 963 are exclusive.

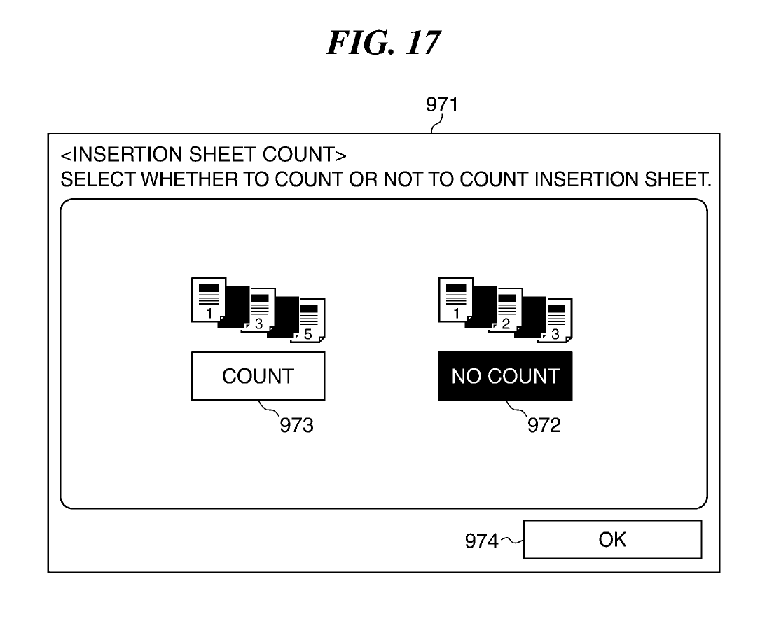

A “detailed setting” button 964 can be depressed when it is set that an interleaf sheet is inserted. When a user depresses the button 964, the insertion sheet count setting screen shown in FIG. 17 is displayed.

When a user depresses an OK button 966, the CPU 201 stores the page numbering setting of the page numbering block into the memory 202 as the job setting, and displays the page numbering block setting screen 901.

On the other hand, when the user depresses a setting cancel button 965, the CPU 201 does not store the page numbering setting of the page numbering block into the memory 202 as the job setting, and displays the page numbering block setting screen 901.

FIG. 17 is a view showing an insertion sheet count screen 971 displayed on the LCD 203 in FIG. 6. The interleaf sheet detailed setting screen 971 in FIG. 17 is displayed when the “detailed setting” button 964 in FIG. 16 is pushed as mentioned above.

A “count” button 973 and a “no count” button 972 are displayed on the insertion sheet count setting screen 971. When the “count” button 973 is selected under the condition where the interleaf sheet setting is set to insert an interleaf sheet, the inserted interleaf sheet is subjected to the count of the page numbering. When the “no count” button 972 is selected under the same condition, the inserted interleaf sheet is not subjected to the count of the page numbering.

A user selects one button to set counting or not counting. When the user selects one button and depresses an OK button 974, the page numbering detailed setting screen is displayed.

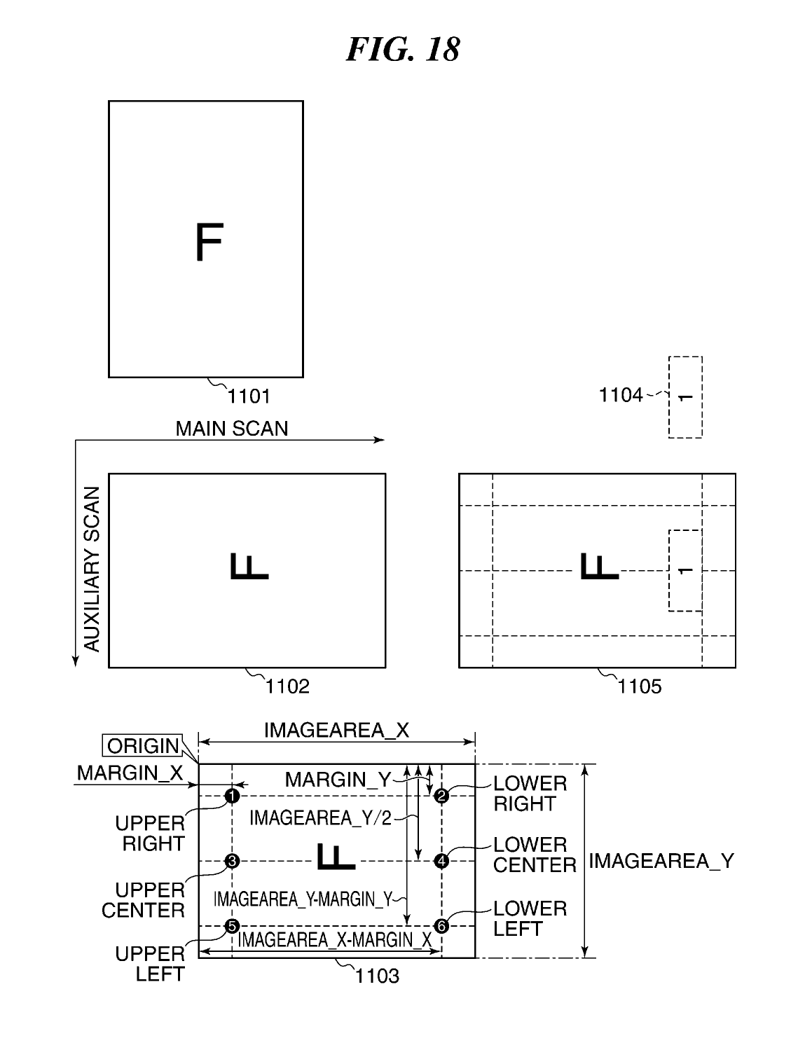

FIG. 18 is a view for describing composition of a page number. As shown in FIG. 18, when an original 1101 is read with the scanner 102, image data 1102 is developed on the memory 202. When printing page numbers, a position 1103 at which a page number is printed on the image that is printed according to the image data is determined.

The position of the page number on the memory 202 is calculated according to the designation by the print position setting button 958, and the page number (and character string if needed) is composed at the calculated position. When the upper right is designated, the page number is composed at the position (1). When the upper left is designated, the page number is composed at the position (5).

When the upper right is designated, the page number (and character string if needed) is not merely arranged at the upper right of the image, but is arranged inside with a margin that has been set in the apparatus. Accordingly, the coordinate of the upper right page printing position is (MARGIN X, MARGIN Y).

Moreover, when the upper left is designated, the page number is arranged at the position (5) of which the coordinate is (MARGIN X, IMAGEAREA Y-MARGIN Y). After determining the print position, the image 1104 for the page numbering and the image data 1102 are composed, and an image 1105 is generated and is printed on a recording sheet.

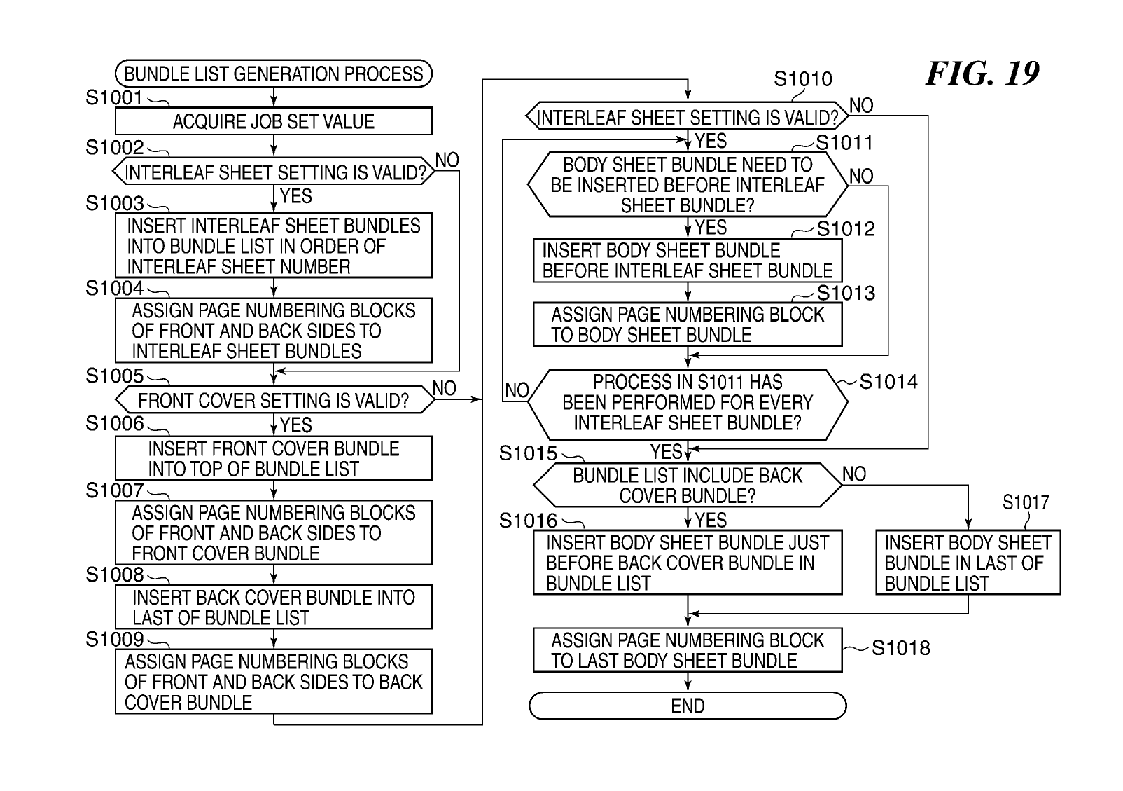

FIG. 19 is a flowchart showing a bundle list generation process executed by the CPU 201 in FIG. 3. This bundle list generation process is executed when displaying the page numbering block list 902 in FIG. 15.

As shown in FIG. 19, the CPU 201 acquires the job set value from the memory 202 (step S1001). Moreover, the CPU 201 reserves an area that stores a bundle list of a list structure for expressing output sheet bundles in the page numbering block list 902 in the memory 202.

Next, the CPU 201 determines whether the interleaf sheet setting is valid or not based on the job set value acquired(step S1002). When the interleaf sheet setting is invalid (NO in the step S1002), the process proceeds to step S1005.

When the interleaf sheet setting is valid (YES in the step S1002) on the other hand, the CPU 201 inserts the interleaf sheet bundles into the bundle list in order of the interleaf sheet number (step S1003).

Then, the CPU 201 assigns the page numbering blocks of the front and back sides to the interleaf sheet bundles inserted into the bundle list (step S1004).

Next, the CPU 201 determines whether the front cover setting is valid or not based on the job set value (step S1005). When the front cover setting is invalid (NO in the step S1005), the process proceeds to step S1010.

When the front cover setting is valid (YES in the step S1005) on the other hand, the CPU 201 inserts a front cover bundle into the top of the bundle list (step S1006). Then, the CPU 201 assigns the page numbering blocks of the front and back sides to the front cover bundle inserted (step S1007).

Then, the CPU 201 inserts a back cover bundle into the last of the bundle list (step S1008), and assigns the page numbering blocks of the front and back sides to the back cover bundle inserted (step S1009).

Next, the CPU 201 determines whether the interleaf sheet setting is valid or not based on the job set value (step S1010). When the interleaf sheet setting is invalid (NO in the step S1010), the process proceeds to step S1015.

When the interleaf sheet setting is valid (YES in the step S1010) on the other hand, the CPU 201 determines whether the body sheet bundle needs to be inserted before the interleaf sheet bundle (step S1011).

In this step S1011, when the interleaf sheet bundle concerned is the top interleaf sheet bundle, the CPU 201 determines that: (1) the insertion of the body sheet bundle is not necessary when the front cover bundle and the interleaf sheet bundle are continuous (i.e., the front cover bundle is just before the interleaf sheet bundle), or (2) the insertion of the body sheet bundle is necessary when the front cover bundle and the interleaf sheet bundle are not continuous.

Moreover, when the front cover bundle is not just before the interleaf sheet bundle, the interleaf sheet bundle concerned is the second or later interleaf sheet bundle. In such a case, the CPU 201 determines that the body sheet bundle needs to be inserted. In other than the top interleaf sheet bundle, when the immediately preceding interleaf sheet bundle and the interleaf sheet bundle to be inserted are continuous, the CPU 201 determines that the insertion of the body sheet bundle is unnecessary. When the interleaf sheet bundles are not continuous, the CPU 201 determines that the insertion of the body sheet bundle is necessary.

When the CPU 201 determined that the body sheet bundle did not need to be inserted (NO in the step S1011), the process proceeds to step S1014.

When it was determined that the body sheet bundle needed to be inserted (YES in the step S1011) on the other hand, the CPU 201 inserts the body sheet bundle before the interleaf sheet bundle (step S1012). Then, the CPU 201 assigns the page numbering block to the body sheet bundle (step S1013).

Next, the CPU 201 determines whether the body sheet bundle insertion determination process in the step 51011 has been performed for every interleaf sheet bundle (step S1014). When the determination result in the step S1014 is NO, the process returns to the above-mentioned step S1011.

When the determination result in the step S1014 is YES on the other hand, the CPU 201 determines whether the bundle list includes a back cover bundle or not based on the job set value (step S1015).

When the bundle list does not include a back cover bundle (NO in the step S1015), the CPU 201 inserts the body sheet bundle in the last of the bundle list (step S1017), and proceeds with the process to step S1018.

On the other hand, when the bundle list includes a back cover bundle (YES in the step S1015), the body sheet bundle is inserted just before the back cover bundle in the bundle list (step S1016).

Then, the CPU 201 assigns the page numbering block to the last body sheet bundle (step S1018), and finishes this process.

The steps S1004, S1009, S1013, and S1018 in the printing process mentioned above are not executed when the page numbering is invalid with the page numbering invalid button 970. Since this bundle list generation process is used when the CPU 201 controls the printer 103, the CPU 201 corresponds to a control unit that controls the printer 103 so as to print page numbers on the recording sheets except for the designated recording sheets.

The CPU 201 displays the page numbering block list 902 in the order of the bundles according to the generated bundle list, and displays the page numbering detailed setting buttons 903 through 910 corresponding to the page numbering blocks of the front and back sides of the bundles.

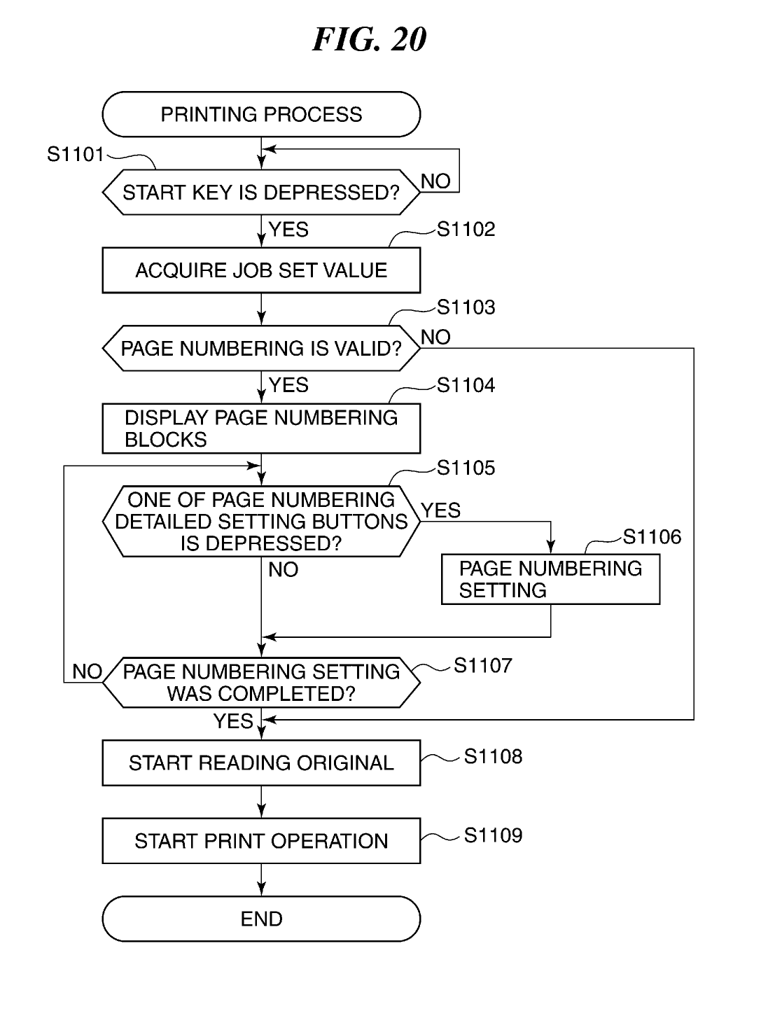

FIG. 20 is a flowchart showing a printing process executed by the CPU 201 in FIG. 3. This printing process is executed by the CPU 201 when the start key 402 is depressed and an execution instruction of a copy job is received.

As shown in FIG. 20, the CPU 201 waits for depression of the start key 402 (step S1101). When the start key 402 is depressed, the CPU 201 acquires the job set value from the memory 202 (step S1102).

Next, the CPU 201 determines whether the page numbering is valid or not based on the job set value (step S1103). When the page numbering is invalid (NO in the step S1103), the process proceeds to step S1108.

On the other hand, when the page numbering is valid (YES in the step S1103), the process proceeds to step S1104. Then, the CPU 201 displays the page numbering blocks on the page numbering block list 902 using the bundle list generated by the bundle list generation process in FIG. 19 (step S1104).

Next, the CPU 201 determines whether one of the page numbering detailed setting buttons is depressed (step S1105). When none of the page numbering detailed setting buttons is depressed (NO in the step S1105), the process proceeds to step S1107.

On the other hand, when one of the page numbering detailed setting buttons is depressed (YES in the step S1105), the CPU 201 displays the page numbering detailed setting screen 951 of the page numbering block corresponding to the depressed button. Then, the CPU 201 reflects the page numbering setting inputted by the user to the job set value, and stores it into the memory 202 (step S1106).

Next, the CPU 201 determines whether the page numbering setting was completed (step S1107). Completion of the page numbering setting is determined by whether the setting cancel button 911 or the setting completion button 912 was pushed.

When the page numbering setting is not completed (NO in the step S1107), the process proceeds to step S1105.

When the page numbering setting was completed (YES in the step S1107) on the other hand, the CPU 201 starts the operation for reading an original (step S1108). Then, the CPU 201 executes a print operation according to the page numbering setting, the front cover setting, the back cover setting, the interleaf sheet setting, etc. (step S1109). Specifically, the CPU 201 controls the printer 103 so as to sequentially give page numbers to the pages belonging to the blocks that are set to give page numbers and so as not to give a page number to the pages belonging to the blocks that are set not to page numbers, while controlling the printer to print images of originals. Then, this process will be finished when the print operation is completed.

As described above, the detailed setting of the page numbering becomes available after depressing the start key 402 under the condition where the settings about the front and back covers and the interleaf sheets have been completed in the printing process in FIG. 20.

Accordingly, the frequency of wrong page numbering settings that are different from a user's intention can be reduced. Moreover, the printing process in FIG. 20 generates a page numbering block from a job set value and displays it. A user performs the page numbering setting to the page numbering block. Accordingly, it is not necessary to generate a preview image during the process from a start of original reading to a completion of printing.

In the printing process in FIG. 20 mentioned above, the reading operation of an original is started after the page numbering setting is completed. However, the page numbering setting may be performed after the reading operation of an original is completed.

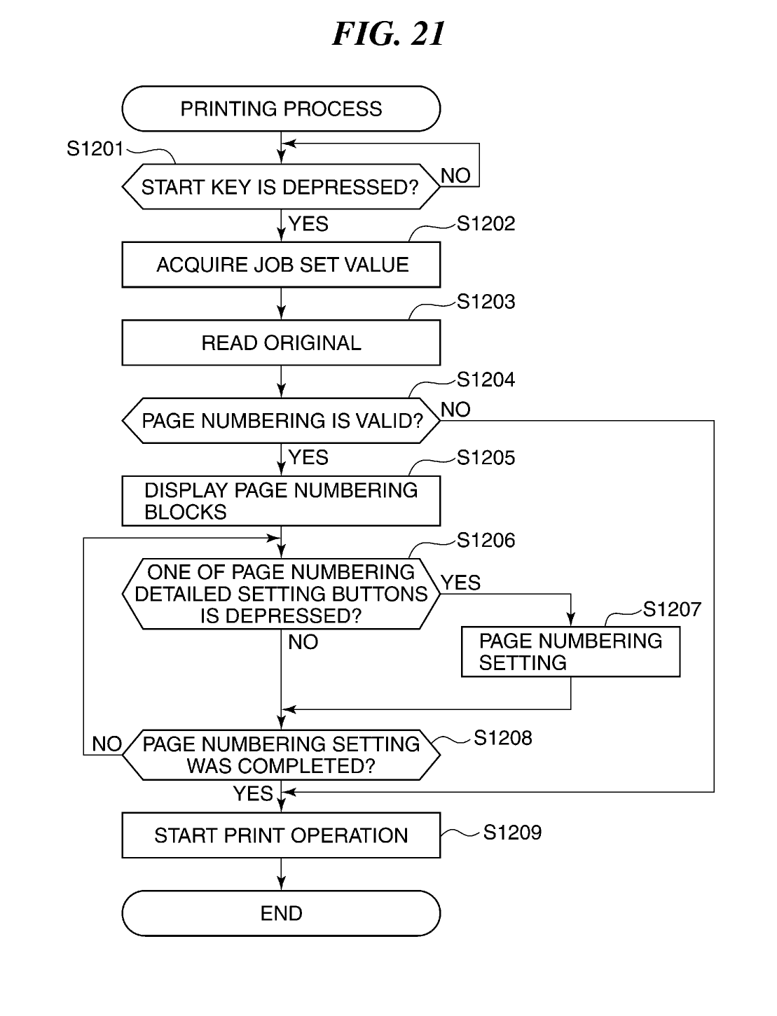

FIG. 21 is a flowchart showing a variation of the printing process executed by the CPU 201 in FIG. 3. This printing process is executed by the CPU 201 when the start key 402 is pressed and an execution instruction of a copy job is received.

As shown in FIG. 21, the CPU 201 waits for depression of the start key 402 (step S1201). When the start key 402 is depressed, the CPU 201 acquires the job set value from the memory 202 (step S1202).

Next, the CPU 201 starts the reading operation of an original (step S1203). When finishing the reading operation, the CPU 201 determines whether the page numbering is valid or not based on the job set value (step S1204). When the page numbering is invalid (NO in the step S1204), the process proceeds to step S1209.

On the other hand, when the page numbering is valid (YES in the step S1204), the process proceeds to step S1205. Then, the CPU 201 displays the page numbering blocks on the page numbering block list 902 using the bundle list generated by the bundle list generation process in FIG. 19 (step S1205).

Next, the CPU 201 determines whether one of the page numbering detailed setting buttons was depressed (step S1206). When none of the page numbering detailed setting buttons is depressed (NO in the step S1206), the process proceeds to step S1208.

On the other hand, when one of the page numbering detailed setting buttons is depressed (YES in the step S1206), the CPU 201 displays the page numbering detailed setting screen 951 of the page numbering block corresponding to the depressed button. Then, the CPU 201 reflects the page numbering setting inputted by the user to the job set value, and stores it into the memory 202 (step S1207).

Next, the CPU 201 determines whether the page numbering setting was completed (step S1208). Completion of the page numbering setting is determined by whether the setting cancel button 911 or the setting completion button 912 was pushed.

When the page numbering setting is not completed (NO in the step S1208), the process proceeds to step S1206.

When the page numbering setting was completed (YES in the step S1208) on the other hand, the CPU 201 starts the printing operation according to the page numbering setting, the front cover setting, the back cover setting, the interleaf sheet setting, etc. (step S1209), and finishes this process. Specifically, the CPU 201 controls the printer 103 so as to sequentially give page numbers to the pages belonging to the blocks that are set to give page numbers and so as not to give a page number to the pages belonging to the blocks that are set not to page numbers, while controlling the printer to print images of originals. Then, this process will be finished when the print operation is completed.

Thus, since the detailed setting of the page numbering is performed after reading an original in this variation, the number of sheets can be displayed with icons.

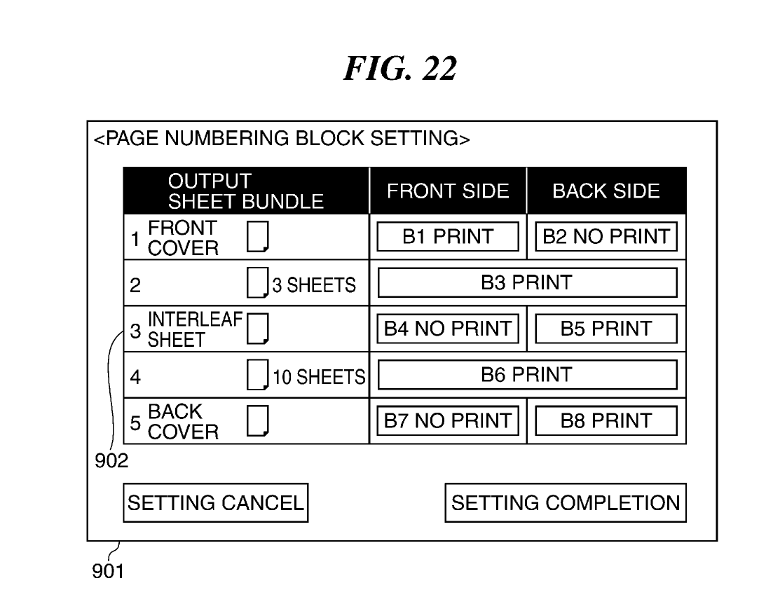

FIG. 22 is a view showing a page numbering block setting screen including sheet counters.

The page numbering block list 902 shown in FIG. 22 is configured to add the sheet counters for the body sheet bundles to the page numbering block list 902 shown in FIG. 15. Thus, the page numbering block list 902 further includes the information showing the number of the body sheets.

Displaying of the sheet numbers of the body sheet bundles allows a user to recognize the output result, which reduces the frequency of wrong page numbering settings that are different from a user's intention. Moreover, the printing process in FIG. 21 generates a page numbering block from a job set value and displays it. A user performs the page numbering setting to the page numbering block. Accordingly, it is not necessary to generate a preview image during the process from a start of original reading to a completion of printing.

As shown in the printing processes in FIG. 20 and FIG. 21, when images read with the scanner 102 are printed with the printer 103, a user can set recording sheets to which page numbers are not given at the following timings in the embodiment. A user can set recording sheets to which page numbers are not given before the scanner 102 reads originals (FIG. 20) or after the scanner 102 reads originals (FIG. 21).

The above-mentioned embodiment describes the copy job in which the printer 103 prints an image of an original read by the scanner 102 on a recording sheet according to set-up values of the copy job set by a user, as an example. The present invention is not limited to this and may be applied to the case of performing a print job in which the printer 103 prints an image according to print data received from an external apparatus like a PC through a network and the network interface 105. In such a case, a CPU of a PC displays the screens shown in FIG. 7 through FIG. 17 on a display of the PC, and a user can perform the page numbering setting through an operation unit of the PC. Moreover, the CPU of the PC should execute the process shown in FIG. 19 in order to display the screen shown in FIG. 15 on the display of the PC. Then, after receiving the page numbering setting from the user, the CPU of the PC transmits the print data with the setting concerned to the printing apparatus 100, and the printing apparatus 100 should execute a print operation according to the received print data.

Moreover, the CPU 201 of the printing apparatus 100 may spool the print data received from the PC into the memory 202 of the printing apparatus 100, and may display the screens shown in FIG. 7 through FIG. 17 to receive an interleaf sheet setting from a user for the print data spooled.

### Other Embodiments

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-168548, filed on Jul. 30, 2012, which is hereby incorporated by reference herein in its entirety.

What is claimed is:

1. A printing apparatus comprising:
a printing unit configured to print an image on a recording sheet;
a setting unit configured to set information about whether to give a page number to a recording sheet for each block that includes one or more recording sheets among recording sheets on which images are printed by said printing unit; and
a control unit configured to control said printing unit so as to print a page number on a recording sheet based on the information set by said setting unit.

2. The printing apparatus according to claim 1, further comprising:
a reading unit configured to read an image on an original,
wherein said setting unit sets the information about whether to give a page number to a recording sheet before said reading unit reads originals, when said printing unit print images of the originals read by said reading unit.

3. The printing apparatus according to claim 1, further comprising:
a reading unit configured to read an image on an original,
wherein said setting unit sets the information about whether to give a page number to a recording sheet after said reading unit reads originals, when said printing unit print images of the originals read by said reading unit.

4. The printing apparatus according to claim 1, wherein the recording sheets include at least one of a front cover, an interleaf sheet, and a back cover, and body sheets, which differ from the front cover, the interleaf sheet, and the back cover, and
wherein said control unit displays a screen including icons showing a block of the front cover, a block of the interleaf sheet, a block of the back cover, and blocks of the body sheets that are arranged in the outputting order from the printing apparatus on a display unit.

5. The printing apparatus according to claim 4, wherein the screen further includes information that shows the number of the body sheets.

6. The printing apparatus according to claim 4, wherein said setting unit can set information about whether the printing unit prints images on the front cover, the interleaf sheet, and the back cover.

7. The printing apparatus according to claim 1, wherein said setting unit can set the start number of the page numbers given to body sheets continuously outputted from the printing apparatus.

8. A control method for a printing apparatus having a printing unit that can print an image on a recording sheet, the control method comprising:
a setting step of setting information about whether to give a page number to a recording sheet for each block that includes one or more recording sheets among recording sheets on which images are printed by said printing unit; and
a control step of controlling the printing unit so as to print a page number on a recording sheet based on the information set in said setting step.

9. A non-transitory computer-readable storage medium storing a control program causing a computer to execute a control method for a printing apparatus having a printing unit that can print an image on a recording sheet, the control method comprising:
a setting step of setting information about whether to give a page number to a recording sheet for each block that includes one or more recording sheets among recording sheets on which images are printed by said printing unit; and
a control step of controlling the printing unit so as to print a page number on a recording sheet based on the information set in said setting step.

10. A printing apparatus comprising:
a printing unit configured to print an image on a recording sheet;
a setting unit configured to set information about whether to give a page number for each of blocks that are divided by an interleaf sheet when said printing unit prints images on recording sheets; and
a control unit configured to control said printing unit so as to give a page number to a page belonging to the block that said setting unit sets to give a page number.
